(19) United States
(12) Patent Application Publication
(10) Pub. No.: US 2025/0209015 A1
(43) Pub. Date: Jun. 26, 2025

(54) DYNAMIC AND SCALABLE MONITOR CALLBACKS

(71) Applicant: ADVANCED MICRO DEVICES, INC., Santa Clara, CA (US)

(72) Inventors: Mark Unruh Wyse, Bellevue, WA (US); Anthony Thomas Gutierrez, Seattle, WA (US); Stephen Alexander Zekany, Redmond, WA (US)

(21) Appl. No.: 18/389,954

(22) Filed: Dec. 20, 2023

(51) Int. Cl. G06F 11/30; G06F 9/54

(52) U.S. Cl. CPC G06F 13/1652; G06F 9/546; G06F 2209/548

(57) ABSTRACT

A processing system employs a hardware signal monitor (HSM) to manage signaling for processing units. The HSM monitors designated memory addresses assigned to signals generated by one or more processing units. Moreover, a single HSM is used to receive and process multiple signals, such as processing different signals received from the one or more processing units. Thus, the HSM improves scalability by managing multiple signals and correspondingly, is able to monitor a greater number of active tasks completed by the one or more processing units.

### BACKGROUND

Signals are a shared memory object employed in some processing systems to facilitate communication between a central processing unit (CPU) and one or more accelerators that perform operations on behalf of the CPU. For example, some processing systems employ a graphics processing unit (GPU) to perform graphics operations, an artificial intelligence engine (AIE) to perform AI operations, a data processing unit (DPU) to perform network processing operations, and the like. To improve processing efficiency and conserve power, hardware signal monitor circuitry (referred to as a hardware signal monitor or HSM, for brevity) monitor memory writes to memory addresses assigned to the signals. However, existing approaches to HSMs can be relatively inflexible and can require a relatively large amount of hardware to handle large numbers of signals.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that employs a hardware signal monitor to manage a plurality of signals based on a task ID in accordance with some embodiments.

FIG. 2 is a block diagram of a processing system that employs a hardware signal monitor to manage a plurality of signals based on an interrupt code in accordance with some embodiments.

FIG. 3 is a block diagram of a processing system that employs hardware signal monitors to invoke different processing units based on dynamic callback execution in accordance with some embodiments.

FIG. 4 is a block diagram of a processing system that employs hardware signal monitors to invoke multiple processing units based on dynamic callback execution in accordance with some embodiments.

FIG. 5 is a flow diagram of a method of managing a plurality of signals at a hardware signal monitor in accordance with some embodiments.

FIG. 6 is a flow diagram of a method of invoking multiple processing units based on dynamic callback execution in accordance with some embodiments.

### DETAILED DESCRIPTION

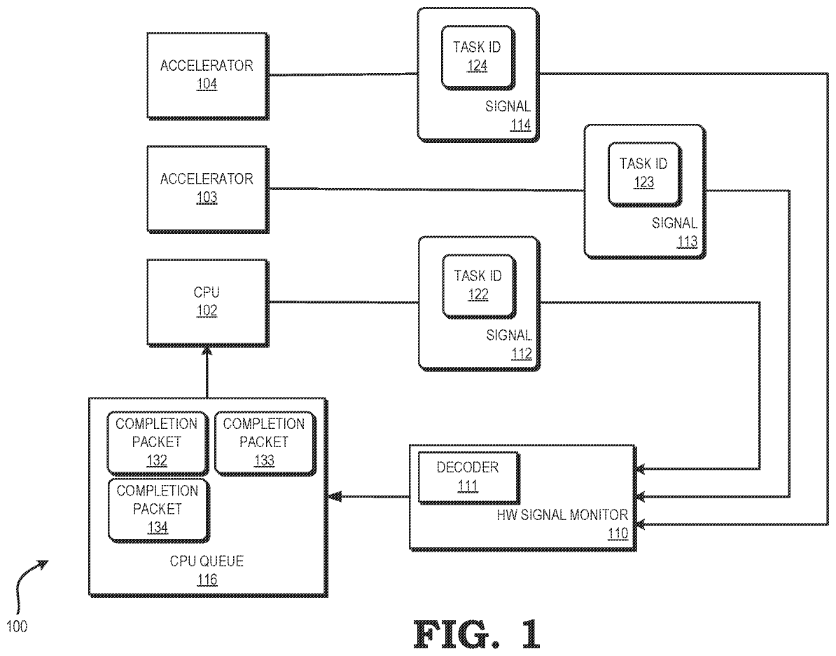

FIGS. 1-6 illustrate systems and techniques for employing a hardware signal monitor to manage signaling for processing units in accordance with some embodiments. The hardware signal monitor (HSM) monitors designated memory addresses assigned to signals generated by one or more processing units. Moreover, in some embodiments, a single HSM is used to receive and process multiple signals, such as processing different signals received from the one or more processing units. Thus, the HSM improves scalability by managing multiple signals and correspondingly, is able to monitor a greater number of active tasks completed by the one or more processing units.

To illustrate, in some embodiments, a processing system includes a number of processing units including at least one CPU and two or more accelerators. To communicate, the processing units employ a set of signals, wherein each signal is a memory-backed object assigned a corresponding memory address. In response to completion of a task, each of the processing units sends a signal, such as a completion signal, to the corresponding memory address. In various embodiments, the HSM observes each signal and checks a stored value provided by each signal. In some embodiments, the stored value includes a task ID from the processing unit that sent the signal. In response to processing the stored value, the HSM enqueues a completion packet that includes the task ID to a completion queue. In some embodiments, the stored value is an interrupt code that is passed to a processing unit, such as the CPU, identified to receive the interrupt by the interrupt code. Utilizing the task ID or the interrupt code facilitates identification of the processing unit that sends the signal, and thus enables recipient of the signal, such as the CPU, to take responsive action based on the task ID or the interrupt code.

Conventionally, each signal sent by the one or more processing units uses a signal monitor. Stated differently, a one-to-one signal-to-monitor relationship is employed to manage communication between the one or more processing units. However, this approach severely limits scalability as the number of hardware resources is limited. Furthermore, increasing hardware resources results in increased processing usage and lower efficiency. In contrast, by allowing a single HSM to monitor multiple signals, a processing system is able to monitor a large number of signals without a corresponding increase in monitoring circuitry.

In different embodiments, the HSM employs dynamic callback execution. As noted above, a signal is sent to a designated memory address. In response to receiving the signal at the designated memory address, the HSM executes a corresponding callback based on the stored value. For example, based on the stored value, the HSM identifies a set of operations to be executed, and executes the identifying operations. Examples of callbacks executed by the HSM include enqueuing the memory address of the signal, enqueuing a function pointer to a queue for execution by a queue consumer, executing a function at the function pointer, enqueuing a payload at a pointer to a queue specified in the HSM configuration, and the like, or any combination thereof. By employing the stored value to determine the callback, the response to the signal is modified during receipt of the signal. In other words, the response by the HSM from executing the callback is adjustable despite receiving signals from the same processing unit. Further, depending on the stored value to determine the callback provides dynamic callback execution, as opposed to simply executing the same callback operation in response to receiving any signal.

In contrast, a conventional approach to callback execution by a signal monitor employs a predefined callback configuration. Specifically, the callback used by the signal monitor is generated at creation of the signal monitor. The callback used by the signal monitor is static and is unable to be altered, regardless of any value stored in the signal. This approach limits flexibility of the callback because the type of action taken is determined prior to execution of the task that results in the signal. Therefore, the action taken is not always applicable to the task that is completed.

FIG. 1 illustrates a block diagram of a processing system 100 in accordance with some embodiments. The processing system 100 is generally configured to execute sets of instructions (e.g., computer programs) in order to carry out operations, as specified by the instructions, on behalf of an electronic device. Accordingly, in different embodiments, the processing system 100 is part of any one of a number of electronic devices, such as a desktop or laptop computer, a server, a smartphone, a tablet, a game console, and the like.

To facilitate execution of instructions, the system 100 includes a CPU 102 and a set of accelerators (e.g., accelerators 103 and 104). It will be appreciated that the number of accelerators illustrated in FIG. 1 is an example only, and that in other embodiments the system 100 includes more or fewer accelerators. In addition, in some embodiments the system 100 includes additional circuitry, not illustrated in FIG. 1, that supports the execution of instructions, such as one or more memory controllers, one or more input/output controllers, one or more memory modules, and the like, or any combination thereof. In some embodiments the CPU 102 and the accelerators 103 and 104 are part of a single processor. In other embodiments, one or more of the accelerators 103 and 104 is external to the system 100. In other embodiments, the CPU 102 and the accelerators 103 and 104 are part of the same integrated circuit package but are incorporated in separate integrated circuit dies.

The CPU 102 is generally configured to execute sets of instructions for the system 100. Thus, in some embodiments, the CPU 102 includes one or more processor cores, wherein each processor core includes one or more instruction pipelines. Each instruction pipeline includes circuitry configured to fetch instructions from a set of instructions assigned to the pipeline, decode each fetched instruction into one or more operations, execute the decoded operations, and retire each instruction once the corresponding operations have completed execution. In the course of executing at least some of these operations, the CPU 102 generates operations to be executed by one of the accelerators 103 and 104.

Each of the accelerators 103 and 104 is circuitry configured to execute specified operations on behalf of the CPU 102. For example, in different embodiments each of the accelerators 103 and 104 is one of a GPU, a vector processor, a general-purpose GPU (GPGPU), a non-scalar processor, a highly-parallel processor, an artificial intelligence (AI) processor, an inference engine, a machine learning processor, a data processing unit (DPU), a network controller, and the like. Further, in at least some embodiments each of the accelerators 103 and 104 is a different type of accelerator.

To facilitate communication of operations, and the results of operations, between the CPU 102 and the accelerators 103 and 104, the processing system 100 is configured to support a signals architecture. Specifically, the CPU 102 and the accelerators 103 and 104 are configured to communicate information, such as status information, via a set of signals, wherein each signal is a shared memory object accessible by at least two of the CPU 102, the accelerator 103, and the accelerator 104. To improve signal communication and handling, the processing system 100 includes a hardware signal monitor (HSM) 110. In various embodiments, the HSM 110 is circuitry that is configured to monitor one or more signals stored in a memory (not shown).

As noted above, one way to monitor multiple signals is to increase a number of HSMs, such that each signal has an HSM to manage communication between the one or more processing units. However, increasing the number of HSMs to monitor each signal increases use of processing resources and lowers efficiency. Moreover, additional HSMs add additional complexity and consume more area on an integrated circuit die. Accordingly, to facilitate more efficient signal management, the HSM 110 is configured to receive and/or monitor multiple signals, such as different signals from multiple processing units, multiple signals from the same processing unit, or any combination thereof. To illustrate via an example, the HSM 110 receives and/or monitors a signal 112 from the CPU 102, a signal 113 from the accelerator 103, and a signal 114 from the accelerator 104. In order to track the respective origins of the signal 112, the signal 113, and the signal 114, in some embodiments, the CPU 102, the accelerator 103, and the accelerator 104 encode a stored value in the signals. The stored value in the signal is a specified data object in the signal used to identify or indicate the origin (e.g., a processing unit sending the signal) of the signal. In some embodiments, the stored value includes a task identifier (ID). During generation of the signal 112, the signal 113, and the signal 114, the CPU 102, the accelerator 103, and the accelerator 104 include a task ID 122, a task ID 123, and a task ID 124, respectively. The HSM 110 tracks the signal 112, the signal 113, and the signal 114 based on the task ID 122, the task ID 123, and the task ID 124, respectively.

Furthermore, in response to receiving the signal 112, the signal 113, and the signal 114, the HSM 110 is configured to enqueue completion packets into a CPU queue 116, which is also referred to as a completion queue 116. The completion packets contain data to be read by the CPU 102. Specifically, the completion packets identify tasks completed by the respective processing units, such that the CPU 102 identifies processing units that are available for additional tasks. In some embodiments, the CPU queue 116 stores one or more completion packets, such as completion packet 132, completion packet 133, and completion packet 134. The completion packet 132, the completion packet 133, and the completion packet 134 include the task ID 122, the task ID 123, and the task ID 124, respectively, corresponding to the processing unit that executed the task. Furthermore, each completion packet includes stores information, such as commands and corresponding data for the CPU 102 to execute additional operations. Based on use of the task IDs, the HSM 110 observes and responds to signals from a large number of signal writers (e.g., the CPU 102, the accelerators 103 and 104). It will be appreciated that while the signal 112, the signal 113, and the signal 114 are illustrated as a single signal in FIG. 1 for ease of description, in various embodiments, the signal 112, the signal 113, and the signal 114 represent a plurality of signals transmitted from the CPU 102, the accelerator 103, and the accelerator 104, respectively.

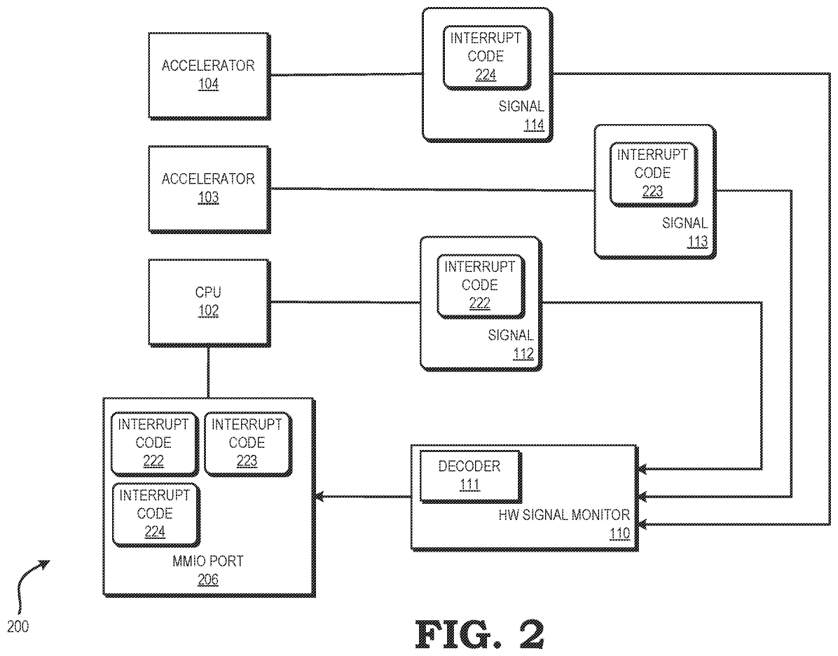

FIG. 2 illustrates a block diagram of a processing system 200 using interrupt codes in accordance with some embodiments. The processing system 200 may implement or be implemented by aspects of the processing system 100 as described with reference to FIG. 1. In the depicted example, the HSM 110 receives and/or monitors the signal 112 from the CPU 102, the signal 113 from the accelerator 103, and the signal 114 from the accelerator 104. The CPU 102, the accelerator 103, and the accelerator 104 include the stored value in the signals. In some embodiments, the stored value includes an interrupt code. During generation of the signal 112, the signal 113, and the signal 114, the CPU 102, the accelerator 103, and the accelerator 104 include an interrupt code 222, an interrupt code 223, and an interrupt code 224, respectively.

In response to receiving the signal 112, the signal 113, or the signal 114, the HSM 110 is configured to send the interrupt code 222, the interrupt code 223, or the interrupt code 224, respectively, to a memory-mapped input/output (MMIO) port 206 connected to the CPU 102. In some embodiments, each interrupt code includes an index directed to an interrupt vector of the CPU 102. The CPU 102 stores a list of interrupts. The index identifies a type of the interrupt and handling of the interrupt based on an event from the signal 112, the signal 113, or the signal 114. In other words, the index identifies the interrupt based on the list of interrupts stored by the CPU 102. The CPU 102 executes a different interrupt handler (e.g., an interrupt service routine or ISR) in response to receiving the interrupt code in the signal. For example, in some embodiments, the ISR indicates an exception handler to respond to events, such as the interrupt code in the signals, or software interrupt handlers that respond to system calls. Moreover, in some embodiments, the interrupt code sent to the CPU 102 is used to prevent the CPU 102 from sending repeated tasks that are already completed by the accelerator 103 or the accelerator 104. Based on the interrupt code, the CPU 102 identifies the processing unit (e.g., the CPU 102, the accelerator 103, the accelerator 104) that generated the interrupt. In the aforementioned example, the interrupt process is described as a software interrupt. However, in different embodiments, the interrupt is a hardware interrupt. For example, the CPU 102 and the accelerators 103 and 104 generate signals that include interrupt codes based on interrupt from an input/output (I/O) device (not shown) connected to the processing system 200. Accordingly, the interrupt code 222, the interrupt code 223, and the interrupt code 224 are included in the signal 112, the signal 113, and the signal 114, respectively, based on input received from the I/O device. It will be appreciated that while the signal 112, the signal 113, and the signal 114 are illustrated as a single signal in FIG. 2 for ease of description, in various embodiments, the signal 112, the signal 113, and the signal 114 represent a plurality of signals transmitted from the CPU 102, the accelerator 103, and the accelerator 104, respectively.

The HSM 110 includes a decoder 111 to decode the stored value. The decoder 111 is used to retrieve the stored value in its original format. As described above, the stored value is encoded in the signals. In order to determine the information in the stored value, the decoder 111 decodes the encoded stored value. As such, the decoder 111 extracts the information in the stored value, such as the task ID or the interrupt code.

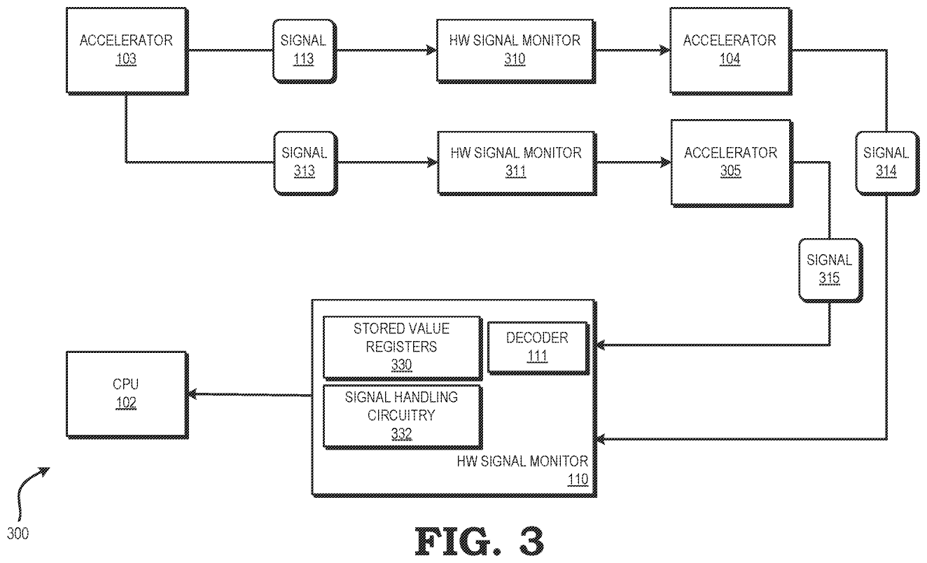

FIG. 3 illustrates a block diagram of a processing system 300 employing dynamic callback execution in accordance with some embodiments. The processing system 300 may implement or be implemented by aspects of the processing system 100 as described with reference to FIG. 1 and/or the processing system 200 as described with reference to FIG. 2. In various embodiments, the processing system 300 employs dynamic callback execution based on the stored value in a signal. To illustrate, the HSM 110 monitors for the stored value in the one or more signals and in response to the stored value, executes one or more specified operations for the signals. The one or more specified operations is referred to as a callback for the signal. Stated differently, the HSM 110 executes the callback based on the stored value. Additionally, each callback varies based on the stored value. Thus, the HSM 110 responds differently based on the stored value, which improves flexibility of signal monitoring and callback execution.

In some embodiments, the HSM 110 further includes stored value registers 330 and signal handling circuitry 332. The stored value registers 330 are a plurality of registers, such that each register stores the stored value received in the one or more signals. In various embodiments, the signal handling circuitry 332 includes a microcontroller, a microprocessor, a multicore processor, and the like, configured to execute instructions stored in the stored value registers 330. For example, the signal handling circuitry 332 accesses the stored value in one or more of the stored value registers 330 and based on the stored value executes the callback based on the stored value.

The callback can be changed depending on the stored value in the signal. In some embodiments, the stored value includes a queue address. For example, in response to receiving the signal with the queue address, the HSM 110 enqueues the signal address or an ID of the processing unit that sent the signal into a specified queue. Alternatively, and/or in addition, in some embodiments, the stored value includes a function pointer. For example, in response to receiving the signal with the function pointer, the HSM 110 enqueues the function pointer to a queue, such as, for example, the CPU queue 116, for execution by the next processing unit. Alternatively, and/or in addition, in some embodiments, in response to receiving the signal with the function pointer, the HSM 110 executes the callback at the function pointer. Alternatively, and/or in addition, in some embodiments, the stored value includes a payload pointer. For example, in response to receiving the signal with the payload pointer, the HSM 110 enqueues the payload at the pointer to a queue specified in a configuration of the HSM 110. Each of the callback operations highlighted above facilitates progress by the processing system 300 from the completed task to the next task. For example, by enqueuing the signal address of the processing unit that sent the signal, the HSM 110 identifies the task has been completed. As another example, receiving the function pointer in the signal provides the next task directly to the next processing unit (e.g., the CPU 102). To further enhance flexibility of the callback, the stored value has a range of bit sizes. For example, in some embodiments, the stored value has 64-bits, 256-bits, 512-bits. However, in other embodiments, the stored value has more than 512-bits or fewer than 64-bits.

In some embodiments, dynamic monitor callbacks are employed using heterogenous task dispatch. The processing system 300 includes an accelerator 305. In some embodiments, the accelerator 103 completes a task and based on the task dynamically invokes or chooses another processing unit to execute the next task, such as the accelerator 104 or the accelerator 305. To illustrate via an example, the accelerator 103 completes the task, which identifies the accelerator 104 for continuing the next task. In some embodiments, the next task performed by the accelerator 104 is a new task. However, in different embodiments, the next task for the accelerator 104 is a continuation of the task that is at least partially performed by the accelerator 103. The accelerator 103 sends the signal 113 to an HSM 310. The HSM 310 receives the signal 113 and based on the stored value in the signal 113 identifies the accelerator 104 as the recipient for the next task. In other words, the accelerator 104 is invoked to perform the next task. Upon completion of the next task, the accelerator 104 sends the signal 314 to the HSM 110. The HSM 110 receives the signal 314 and based on the stored value in the signal 314 identifies the CPU 102 as the recipient for the next task. In particular, in some embodiments, the HSM 110 enqueues the stored value (e.g., a task ID) into a completion packet queue as described above with respect to FIG. 1 or the HSM 110 sends the interrupt code to an MMIO as described above with respect to FIG. 2.

Alternatively, after completing the task, the accelerator 103 identifies the accelerator 305 for continuing the task. The accelerator 103 sends the signal 313 to an HSM 311. The HSM 311 receives the signal 313 and based on the stored value in the signal 313 identifies the accelerator 305 as the recipient for the next task. Upon completion of the next task, the accelerator 305 sends the signal 315 to the HSM 110. The HSM 110 receives the signal 315 and based on the stored value in the signal 315 identifies the CPU 102 as the recipient for the next task. Accordingly, the HSM 110 performs operations as described above with respect to the signal 314.

In the depicted example, the HSM 310 and the HSM 311 are separate HSMs from the HSM 110. However, it will be appreciated that in some embodiments, the HSM 310 and the HSM 311 are the same HSM. Alternatively, in different embodiments, the HSM 310 and the HSM 311 are not separate, and all of the processes discussed above are performed on a single HSM, the HSM 110.

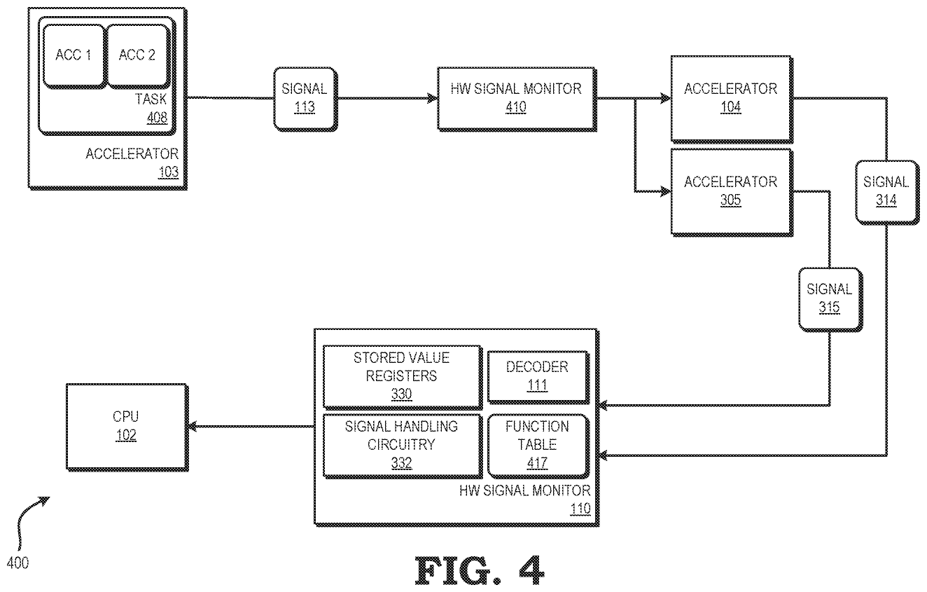

FIG. 4 illustrates a block diagram of a processing system 400 employing dynamic callback execution in accordance with some embodiments. The processing system 200 may implement or be implemented by aspects of the processing system 100 as described with reference to FIG. 1, the processing system 200 as described above with reference to FIG. 2, and/or the processing system 300 as described above with reference to FIG. 3. In some embodiments, the accelerator 103 completes a task 408 and based on the task 408 dynamically invokes or chooses additional processing units to execute the next task, such as the accelerator 104 and the accelerator 305. To illustrate via an example, the accelerator 103 completes the task 408, which identifies a first accelerator (e.g., the accelerator 104) and a second accelerator (e.g., the accelerator 305) for continuing the next task. That is, the accelerators 104 and 305 collaborate on the next task, which is divided based on the task 408 identified by the accelerator 103. For example, in a first scenario, the accelerator 103 divides the next task equally (i.e., 50/50) to the accelerators 104 and 305. However, in a second scenario, the accelerator 103 divides the next task forty percent (40%) to the accelerator 104 and sixty percent (60%) to the accelerator 305. In a third scenario, the accelerator 103 divides the task 60% to the accelerator 104 and 40% to the accelerator 305. Therefore, the division of task varies and differs based on the accelerator 103 identifying performance of the next task. In some embodiments, the next task performed by the accelerator 104 and the accelerator 305 is a new task. However, in different embodiments, the next task for the accelerator 104 and the accelerator 305 is a continuation of the task at least partially performed by the accelerator 103. The accelerator 103 sends the signal 113 to an HSM 410. The HSM 410 receives the signal 113 and based on the stored value in the signal 113 identifies the accelerators 104 and 305 as recipients for the next task. Upon completion of the next task, the accelerators 104 and 305 sends the signals 314 and 315, respectively, to the HSM 110. The HSM 110 receives the signals 314 and 315 and based on the stored values in the signals 314 and 315 identifies the CPU 102 as the recipient for the next task. In particular, in some embodiments, the HSM 110 enqueues the stored values (e.g., a task ID) into a completion packet queue as described above with respect to FIG. 1 or the HSM 110 sends the interrupt codes to an MMIO as described above with respect to FIG. 2. Based on the techniques described above with respect to FIGS. 3 and 4, the dynamic callback execution by the HSM 110 facilitates heterogeneous task dispatch. Moreover, the processing systems 300 and 400 improve processing performance and energy efficiency by dynamically assigning tasks as needed to the one or more processing units (e.g., the accelerators 104 and/or 305).

In other embodiments, dynamic callback execution is employed by the HSMs. For purposes of description, the operations of the processing system 100 are described with respect to example implementations where the HSM 110 employs dynamic callback execution. However, in other embodiments, these operations are implemented at any other HSM, such as the HSMs 310, 311, and/or 410. To dynamically execute the callback, the HSM 110 performs operations based on the stored value of the signal, such as the signal 113 in FIG. 1. For example, in some embodiments, the HSM 110 employs logic and/or a programmable microcontroller (not shown) that interprets the stored value in the signal 113. The HSM 110 identifies the stored value as a command packet (e.g., a heterogeneous system architecture (HSA) architected queuing language (AQL) packet) and executes the callback (i.e., the command packet in the stored value). Alternatively, and/or in addition, the HSM 110 interprets the stored value as an encoded operation or a byte code that is decoded by the decoder 111 or a packet processor of the HSM 110.

In some embodiments, for example, the HSM 110 receives the stored value that encodes a function pointer or a code object. The HSM 110 executes the callback (i.e., the function pointer or the code object) in the stored value. Accordingly, the HSM 110 executes the callback that is included directly in the stored value or pointed to (i.e., by the function pointer). The HSM 110 executes the callback using logic and/or a programmable microcontroller. In some embodiments, the HSM 110 employs a table of functions or a function table 417. The functions in the function table 417 are executed based on the techniques described above. For example, the HSM 110 receives the stored value that includes a function pointer pointing to the function table 417. In response to checking the function table 417, the HSM 110 executes a function within the function table 417 based on a location specified by the function pointer. Furthermore, the function table 417 is modifiable based on the callback. In other words, for example, the HSM 110 receives the stored value that includes a command packet that directs the HSM 110 to update the function table 417 in response to executing the callback. Accordingly, subsequent access to the table by the HSM 110 results in different outcomes due to any updates made to the function table 417. Thus, the functionality of the HSM 110 has improved flexibility to respond to the signal 113 as opposed to a predefined configuration.

In some embodiments, for example, the HSM 110 uses a microcontroller executing firmware to interpret the stored value in the signal 113. Additionally, in some cases, the firmware of the HSM 110 receives an update to change functionality and alter a type of response to the stored value in the signal 113. Stated differently, changing the firmware of the HSM 110 changes the response the HSM 110 interprets the stored value in the signal 113. Therefore, by changing the firmware, the HSM 110 has improved flexibility to adjust the response (i.e., callback execution) without changing hardware.

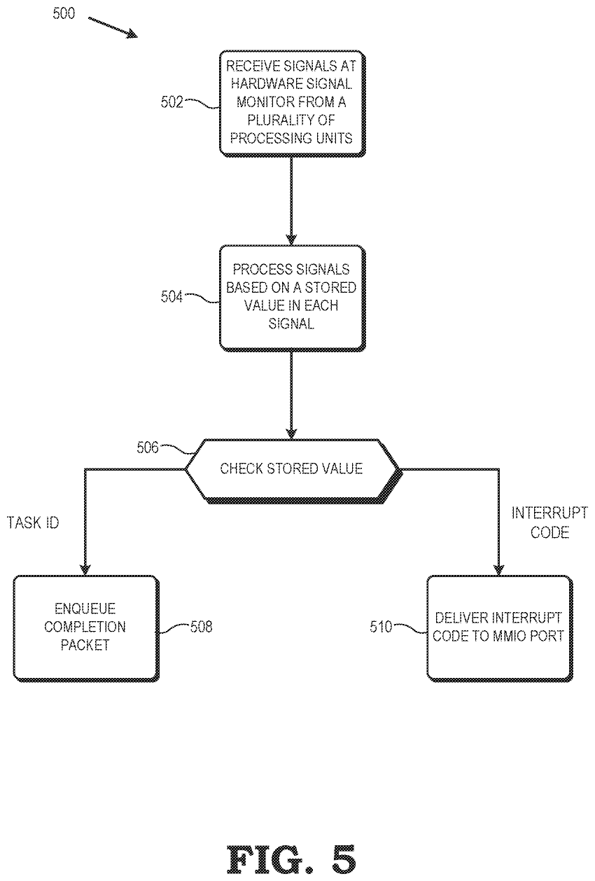

FIG. 5 illustrates a flow diagram of a method 500 of managing a plurality of signals at a hardware signal monitor in accordance with some embodiments. For ease of illustration and description, the method 500 is described below with reference to and in an example context of the processing system 100 of FIG. 1 and the processing system 200 of FIG. 2. However, the method 500 is not limited to this example context, but instead in different embodiments, is employed for any of a variety of possible system configurations using the techniques provided herein.

The method 500 begins at block 502 with the HSM 110 receiving the signal 112 from the CPU 102, the signal 113 from the accelerator 103, and the signal 114 from the accelerator 104. At block 504, the HSM 110 processes the signals 113, 114, and 115 based on the stored value in each signal. At block 506, the HSM 110 checks the stored value to execute the callback based on the stored value. In a first scenario, the HSM 110 identifies the stored values as task IDs. The HSM 110 tracks the signal 112, the signal 113, and the signal 114 based on the task ID 122, the task ID 123, and the task ID 124, respectively. At block 508, in response to receiving the signal 112, the signal 113, and the signal 114, the HSM 110 is configured to enqueue completion packets into a CPU queue 116. In some embodiments, the CPU queue 116 includes one or more completion packets, such as completion packet 132, completion packet 133, and completion packet 134. The completion packet 132, the completion packet 133, and the completion packet 134 include the task ID 122, the task ID 123, and the task ID 124, respectively, corresponding to the processing unit that executed the task.

Alternatively, and/or in a second scenario, the HSM 110 identifies the stored values as interrupt codes. At block 510, in response to receiving the signal 112, the signal 113, and the signal 114, the HSM 110 is configured to send the interrupt code 222, the interrupt code 223, and the interrupt code 224 to the MMIO port 206 connected to the CPU 102.

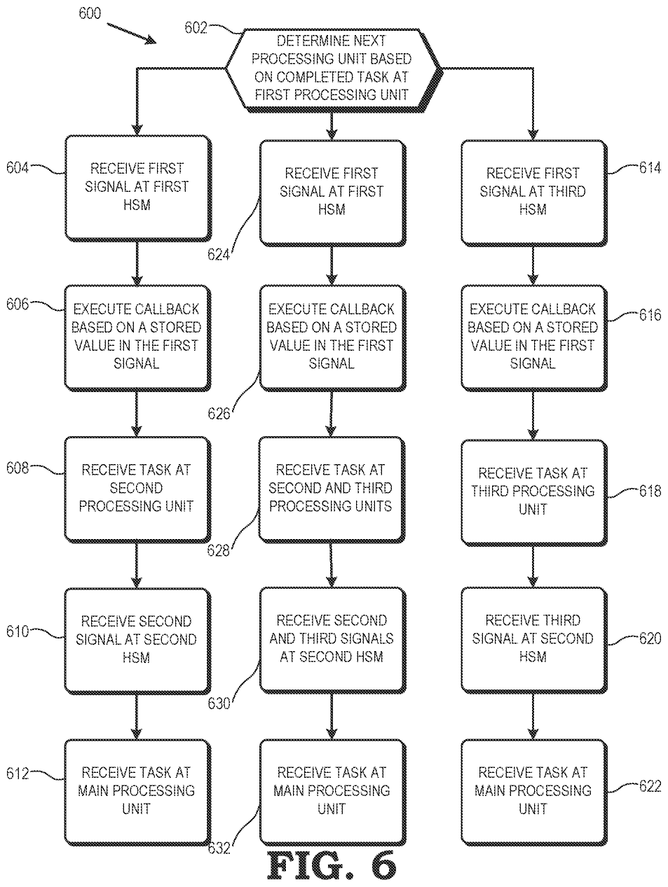

FIG. 6 illustrates a flow diagram of a method 600 of dynamic callback execution in accordance with some embodiments. For ease of illustration and description, the method 600 is described below with reference to and in an example context of the processing system 300 of FIG. 3 and the processing system 400 of FIG. 4. However, the method 600 is not limited to this example context, but instead in different embodiments, is employed for any of a variety of possible system configurations using the techniques provided herein.

The method 600 begins at block 602, the accelerator 103 completes a task and based on the task dynamically chooses another processing unit to execute the next task, such as the accelerator 104 or the accelerator 305. At block 604, the HSM 310 receives the signal 113 from the accelerator 103. At block 606, the HSM 310 executes the callback based on the stored value in the signal that identifies the accelerator 104. At block 608, the accelerator 104 receives the next task. At block 610, upon completion of the next task, the accelerator 104 sends the signal 314 to the HSM 110 and based on the stored value in the signal 314 identifies the CPU 102 as the recipient for the next task. At block 612, the CPU 102 receives the next task.

At block 614, the HSM 311 receives the signal 313 from the accelerator 103. At block 616, the HSM 311 executes the callback based on the stored value in the signal that identifies the accelerator 305. At block 618, the accelerator 305 receives the next task. At block 620, upon completion of the next task, the accelerator 305 sends the signal 315 to the HSM 110 and based on the stored value in the signal 315 identifies the CPU 102 as the recipient for the next task. At block 622, the CPU 102 receives the next task.

At block 624, the HSM 410 receives the signal 113 from the accelerator 103. At block 626, the HSM 410 executes the callback based on the stored value in the signal that identifies the accelerators 104 and 305. At block 628, the accelerators 104 and 305 receive the next task, which is divided based on the task identified by the accelerator 103. At block 630, upon completion of the next task, the accelerators 104 and 305 send the signals 314 and 315, respectively, to the HSM 110 and based on the stored value in the signals 314 and 315 identify the CPU 102 as the recipient for the next task. At block 632, the CPU 102 receives the next task.

In some embodiments, the apparatus and techniques described above are implemented in a system including one or more integrated circuit (IC) devices (also referred to as integrated circuit packages or microchips), such as the processing system 100, the processing system 200, the processing system 300, and/or the processing system 400 described above with reference to FIGS. 1-4, respectively. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
receiving, at a hardware signal monitor (HSM), a first stored value in at least one first signal from a first processing unit;
receiving, at the HSM, a second stored value in at least one second signal from at least one second processing unit; and
notifying, by the HSM, another processing unit in response to processing the at least one first signal based on the first stored value and the at least one second signal based on the second stored value.

2. The method of claim 1, wherein notifying the another processing unit comprises:
enqueuing a first task identification (ID) into a completion queue of the another processing unit; and
enqueuing a second task ID into the completion queue of the another processing unit.

3. The method of claim 2, wherein the first task ID indicates completion of a first task by the first processing unit and the second task ID indicates completion of a second task by the second processing unit.

4. The method of claim 2, wherein the first task ID indicates an origin of the at least one first signal and the second task ID indicates an origin of the at least one second signal.

5. The method of claim 1, wherein notifying the another processing unit comprises:
notifying the another processing unit of a first completed task by the first processing unit and a second completed task by the at least one second processing unit.

6. The method of claim 1, wherein notifying the another processing unit comprises:
delivering a first interrupt code to a memory-mapped input/output (MMIO) port of the another processing unit; and
delivering a second interrupt code to the MMIO port of the another processing unit.

7. The method of claim 6, wherein the first interrupt code corresponds to the first stored value and the second interrupt code corresponds to the second stored value.

8. A method, comprising:
receiving, at a first hardware signal monitor (HSM), a first stored value in a first signal from a first processing unit that has completed a first task; and
executing a callback, by the first HSM, based on the first stored value in the first signal.

9. The method of claim 8, further comprising:
based on execution of the callback, invoking one of:
a second processing unit; and
a third processing unit.

10. The method of claim 9, wherein invoking the second processing unit comprises:
one of:
sending, by the first HSM, the first task to the second processing unit; and
sending, by the first HSM, a second task to the second processing unit, wherein the second task is different from the first task.

11. The method of claim 9, further comprising:
receiving, at a second HSM, a second stored value in a second signal from one of:
the second processing unit; and
the third processing unit; and
notifying, by the second HSM, another processing unit that the first task has been completed in response to processing the second signal based on the second stored value.

12. The method of claim 9, further comprising:
receiving, at a second HSM, a second stored value in a second signal from the second processing unit and a third stored value in a third signal from the third processing unit.

13. The method of claim 8, wherein executing the callback comprises:
interpreting the first stored value as a command packet.

14. The method of claim 8, wherein executing the callback comprises:
executing a function pointer by directing the first HSM to execute a function at a location defined in the first stored value.

15. The method of claim 8, wherein executing the callback is based on a table of functions stored by the first HSM.

16. A system, comprising:
a first processing unit; and
first hardware signal monitor (HSM) circuitry configured to:
receive a first stored value in a first signal from the first processing unit that has completed a first task; and
execute a callback based on the first stored value in the first signal.

17. The system of claim 16, where the first HSM is further configured to:
based on execution of the callback, invoke one of:
a second processing unit; and
a third processing unit.

18. The system of claim 17, further comprising:
a second HSM configured to:
receive a second stored value in a second signal from one of:
the second processing unit; and
the third processing unit; and
notify another processing unit that the first task has been completed in response to processing the second signal based on the second stored value.

19. The system of claim 16, wherein the first HSM is further configured to:
execute a function pointer by directing the first HSM to execute a function at a location indicated by the first stored value.

20. The system of claim 16, wherein the first HSM is further configured to:
store a table of functions that determines the callback during execution.
